(19) United States
(12) Patent Application Publication
(10) Pub. No.: US 2017/0010957 A1
(43) Pub. Date: Jan. 12, 2017

(54) Method for Multithreaded Program Output Uniqueness Testing and Proof-Generation, Based on Program Constraint Construction

(71) Applicant: Xi'an Jiaotong University, Xi'an (CN)

(72) Inventors: Ting LIU, Xi'an (CN); Xiaodong ZHANG, Xi'an (CN); Pei LIU, Xi'an (CN); Lechen YU, Xi'an (CN); Qinghua ZHENG, Xi'an (CN)

(21) Appl. No.: 15/270,266

(22) Filed: Sep. 20, 2016

Related U.S. Application Data
(63) Continuation of application No. PCT/CN2015/081055, filed on Jun. 9, 2015.

(30) Foreign Application Priority Data
Jul. 7, 2014 (CN) 201410320129.0

(51) Int. Cl. G06F 11/36

(52) U.S. Cl. CPC G06F 11/3688; G06F 11/3692

(57) ABSTRACT

Provided is a method for multithreaded program output uniqueness testing and proof-generation, based on program constraint construction; according to multithreaded program semantics, a constraint expression is constructed; an output uniqueness verification problem is converted to a constraint solving problem; a constraint solver is used to detect the presence of different outputs, and a counterexample execution path describing different outputs is generated; first, a tested program is stubbed, and the program is executed to obtain an execution path; then, according to multithreaded program execution semantics, the execution path is converted to a first-order logic expression having no quantifiers, the constraint expression encompassing all possible thread interleavings; then, uniqueness verification conditions are constructed for the output of a first run; lastly, the constraint solver is used for verifying whether a path is causing the output value and the run result to be inconsistent. The present method detects whether the output of a multithreaded program is unique from a given input; if outputs are not unique, a counterexample sequence is displayed to describe the triggering process of same.

### RELATED APPLICATIONS

This is a continuation application of International Application PCT/CN2015/081055 filed on Jun. 9, 2015, which claims the benefit of the Chinese Patent Application CN 201410320129.0 filed Jul. 7, 2014. which are all incorporated herein by reference in their entirety.

### FIELD OF THE INVENTION

The present invention relates to the field of trusted software and software testing. More particularly, this invention relates to a program constraint construction based method for examining output uniqueness of multithread program and generating proof.

### BACKGROUND OF THE INVENTION

With the widespread application of multi-core processors, writing multithread programs with fine performance and structure is an important way to release potential of the multi-core processors. Debugging obscure errors in a multithread program are now an urgent issue. For a serial program, outputs of one input in multiple executions are definitely unique. However, unique outputs of one input are not necessarily generated in multiple executions of a multithread program, for different thread interleaves may be generated in execution processes of the multithread program, which may have different impacts on an execution result of the program. Hence, how to verify output uniqueness of a multithread program is an urgent issue to be solved.

However, there is a difficult in verifying a multithread program and it is hard to reproduce serial errors. A multithread program has the following features: 1) a user can hardly control execution order of all threads; 2) side effects may be generated in a debugger using method of instrumentation or breakpoint debugging, resulting in disappearing of some errors; 3) due to an operating system and a running environment, a sequence in which errors occur seldom reoccurs; and 4) explosion of spatial states is caused by thread interleaving, where, for example, the number of interleave sequences of a program with n threads in each of which k instructions are executed is as many as (nk)!/(k!)n>=(n!)k. Even in an assumption of controllable thread scheduling, a programmer can not enumerate all thread interleaves.

At present, a lot of work has been done on testing and verifying of multithread programs, which includes uncertainty testing and model examining. In an uncertainty testing method based on instruction of a coverage standard, a coverage standard set in each execution is examined to determine elements not yet covered, and a random delay is inserted into the program to increase a possibility of covering other elements in a next execution. In model testing, a state of the program is symbolized and an entire state space is traversed, to find error states in the program. Though model testing solves the issue of verifying multithread programs to some extent, it is subject to the issue of state space explosion, which makes it hard to be applied to a large-scale and complex software system.

### OBJECTS AND SUMMARY OF THE INVENTION

To overcome the disadvantages above in conventional technology, the disclosure is to provide a program constraint construction based method for examining output uniqueness of a multithread program and generating proof, in which constraint expressions are constructed based on semanteme of a multithread program, the issue of verifying output uniqueness is converted into an issue of constraint solving, whether there are different outputs is detected with a constraint solver and counter-example execution paths are generated to describe different outputs.

To achieve the object above, following technical solutions are provided according to the disclosure.

A program constraint construction based method for examining output uniqueness of a multithread program and generating proof is provided, which includes the following steps:

S1), embedding monitoring code into a program to be tested, to record an execution process of the program;

S2), executing the instrumented program at a given input, and generating a path record file;

S3), pre-processing an execution path to facilitate constraint construction;

S4), automatically adding an attribute condition at the end of running of the program, and for a running output of the multithread program, inserting an output uniqueness condition ρ into the program in the form of assert;

S5), converting, based on execution semanteme of the program, state transfers and thread interleaving relationships in the execution path into quantifier-free first-order logic expressions, and constructing a multithread program execution path constraint model F covering all possible interleave sequences;

S6), verifying whether there is a solution to f [symbol] ρ given the uniqueness condition ρ; and

S7), generating a proof sequence if there is a solution which indicates existence of multiple different outputs, and determining that output is unique at the given input if there is no solution.

A further improvement of the invention is that: the instrumentation in step S1) is not performed at a source code or binary level but at a bytecode level, where a specific implementing method thereof includes first converting source code of the multithread program to be tested into bytecode of an intermediate format, that is, LLVM bytecode, then embedding a sentence with a monitoring function into the program to be tested, and finally linking the bytecode with the monitoring code embedded in to generate an executive program.

A further improvement of the invention is that: the pre-processing in step S3) includes extracting a shared variable to recognize an access point of a public variable in the execution path, and slicing to remove an executive sentence irrelevant to a verification attribute.

A further improvement of the invention is that: an output variable is automatically recognized and the output uniqueness condition ρ is constructed therefor in step S4).

A further improvement of the invention is that: the multithread program execution path constraint model F in step S5) covers all possible interleave sequences of the execution path, and includes five constraints: a path expression, a memory model constraint, a read-write relationship constraint, a partial-order constraint and a synchronous semantic constraint, which are defined as follows:

1), the path expression: describing definition-use chains inside threads and controlling state switching inside the threads;

2), the memory model constraint: representing relationships between sentences and between variables in a program and adopting semanteme with sequential consistency, where the sequential consistency provides that a CPU executes a program in an order of sentences in code;

3), the read-write relationship constraint: defining definition-use chains across the threads, and providing that a value read by a shared variable must be from an initial value and a value written recently;

4), the partial-order constraint: defining sequential relationships between operating sentences for creating and terminating a thread and sentences of an operated thread across the threads;

5), the synchronous semantic constraint: defining sequential relationships between synchronization control operating sentences across the threads;

where the definition-use chain is defined as follows: with each thread sequence converted into an SSA format, each execution sequence of the SSA format except shared access points is a complete definition-use chain.

A further improvement of the invention is that: a method for constructing the multithread program execution path constraint model F in step S5) includes the following operations:

1), calculating the path expression to control the state switching inside the threads;

2), calculating the memory model constraint to restrict relationships between sentences in each of the threads;

3), calculating the read-write relationship constraint to establish the definition-use chains across the threads:

4), calculating the synchronous semantic constraint to define synchronization relationships between the threads;

5), calculating the partial-order constraint to describe semanteme for creating and terminating the threads; and

forming the constraint model F by combining the five constraints above.

A further improvement of the invention is that: with an event set of the execution path defined as [symbol] ₙ={Tᵢ|0<i≦k}, where k is the number of the threads, Tᵢ={e₁,e₂,eₙ} is an execution sequence of thread i, eₙ represents an nth event of Tᵢ, O(eₙ) represents a rank of event eₙ and n represents the number of events in Tᵢ,

a method for calculating the path expression includes:

converting each thread sequence into an SSA format, which is similar to collecting of path conditions (Path Condition), and directly converting the sequence of the SSA format into the path expression;

a method for calculating the memory model constraint includes:

performing all operations in accordance with an order of the program with a model with sequential consistency adopted, where an order of events in a thread is subject to the following constraint:

$${Φ}_{mo} = {}_{{T}_{i} ∈ τ} ( {}_{{e}_{i} {e}_{i + 1} ∈ {T}_{i}} O ( {e}_{i} ) < O ( {e}_{i + 1} ) ) ,$$

where eᵢ and eᵢ₊₁ represent two successive events in one thread and τ represents all thread sequences;

a method for calculating the read-write relationship constraint includes:

letting reading of the shared variable be from recent writing, and for one shared variable v, with R representing a set of all events performing a reading operation thereon and W representing a set of all event performing a writing operation thereon, providing the following formula:

$${Φ}_{rw} = {}_{{e}_{r} ∈ R} {}_{{e}_{w} ∈ W} \{ ( {v}_{r} = {v}_{w} ⋀ O ( {e}_{w} ) < O ( {e}_{r} ) ) ⋀ {}_{{e}_{x} ∈ W} ( O ( {e}_{x} ) < O ( {e}_{w} ) ⋀ O ( {e}_{r} ) < O ( {e}_{x} ) ) \} ,$$

where eᵣ is a read event, e_{w} and eₓ are write events, vᵣ and v_{w} are variables operated by events eᵣ and e_{w}, and the meaning of the formula is that a value of vᵣ in event eᵣ is from v_{w} in event e_{w} on condition that eᵣ is after e_{w}, that is O(e_{w})<O(eᵣ), and that all writing is either before e_{w} or after eᵣ;

a method for calculating the synchronous semantic constraint includes two kinds of operations, lock/unlock operations and wait/signal operations:

1), the lock/unlock operations are for constructing a locked synchronous semantic constraint, which requires that any two lock/unlock event pairs lᵢ/uᵢ and lₖ/uₖ in a lock/unlock set L in one mutex are subject to the following formula:

$${Φ}_{syn}^{l / u} = {}_{{l}_{i} / {u}_{i} , {l}_{k} / {u}_{k} ∈ L} O ( {u}_{i} ) < O ( {l}_{k} ) ⋁ O ( {u}_{k} ) < O ( {l}_{i} ) ,$$

where lock pair lᵢ/uᵢ occurs either before or after lock pair lₖ/uₖ; and

2) the wait/signal operations are for constructing a synchronous semantic constraint for condition variables, which is subject to the condition that each wait operation corresponds to one signal operation and one signal operation awakes one wait operation at most, and for one condition variable cond, with WT representing a set of all wait operations on cond and SG representing a set of all signal operations on cond, the following formula is provided to meet the condition above:

$${Φ}_{syn}^{w / s} = {}_{{e}_{wt} ∈ WT} \{ ( {}_{{e}_{sg} ∈ {SG}_{wt}} O ( {e}_{wt} ) > O ( {e}_{sg} ) ⋀ {pair}_{wt}^{sg} = 1 ) ⋀ {\sum }_{e ∈ {SG}_{wt}}^{ } {pair}_{wi}^{e} = 1 \} ,$$

where e_{wt} is an element in WT, SG_{wt} represents a set of signal operations matching e_{wt}, e_{sg} is any signal operation event in SG_{wt}, whether e_{sg} matches e_{wt} is represented by whether variable pair^{sg}_{wt} is equal to 1, and the sub-formula Σ_{e∈SG}_{_{wt}}pair^{e}_{wt}=1 indicates that there has to be a signal operation matching each wait operation;

a method for calculating the partial-order constraint includes:

providing that if an event creates a thread, all events of the created thread are required to be executed after the event and that if an event performs a thread terminating operation, all events of a terminated thread are required to be before the event, and with C representing a set of events of create/fork operations and J representing a set of events of join operations, providing the following constraint:

$${Φ}_{po} = {}_{{e}_{c} ∈ C} O ( {e}_{c} ) < first ( {e}_{c} ) ⋀ {}_{{e}_{j} ∈ j} O ( {e}_{j} ) > last ( {e}_{j} ) ,$$

where e_{c} is a thread creating event, first (e_{c}) is a rank of the first event of a thread created by e_{c}, eⱼ is a thread terminating event and last(eⱼ) is a rank of the last event of a thread terminated by eⱼ; and

the five constraints above are combined to form the constraint model F.

A further improvement of the invention is that: with the given constraint model and the output uniqueness attribute condition, the attribute condition is solved for with the constraint solver in step S6), and if there is a different output, a counter-example is generated to describe a triggering process of the different output.

Compared with conventional technology, the invention has the following beneficial effects:

1), a multithread program execution path constrain model is provided, the issue of verifying output uniqueness of a multithread program is converted into an issue of constraint solving, the model constructs constraints based on semanteme of the program, constructed expressions cover all possible interleave sequences, and whether all the interleaves generate different outputs is examined with a constraint solver;

2), a proof sequence is generated if there are different outputs, to present a user how the different results are generated; and

3), a post-hoc analysis is performed on an execution sequence, without generating a high running cost as in on-the-fly technology.

### BRIEF DESCRIPTION OF FIGURES

FIG. 1 is an overall flowchart of a method according to the disclosure; and

FIG. 2 is a flowchart of a method for constructing a multithread program path constraint.

### DETAILED DESCRIPTION OF THE EMBODIMENTS

Some embodiments of the invention are described hereinafter in conjunction with the figures and an example. A program to be tested is shown as follows, where x and y are shared variables and thread 0 creates threads 1 and 2 in lines 1 and 2.

0: x = 3, y = 1

| Thread 0 | Thread 1 | Thread 2 |
|---|---|---|
| 1: create(1) | 5: a = x; | 11: lock(m); |
| 2: create(2) | 6: b = y; | 12: x ++; |
| 3: join(1) | 7: lock(m); | 13: y ++; |
| 4: join(2) | 8: x = a + 2; | 14: unlock(m); |
| | 9: y = b + 3; | |
| | 10: unlock(m); | |

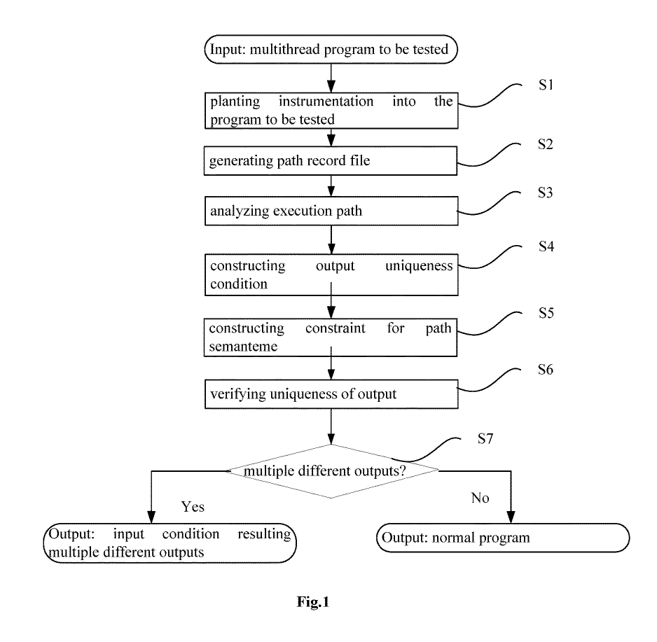

As shown in FIG. 1, a multithread program constraint construction based method for examining output uniqueness is provided, which includes steps S1) to S7).

In step S1), monitoring code is embedded into the program to be tested, to record an execution process of the program. Code presented after the instrumentation is completed at an LLVM bytecode level is shown as follows:

... ...
call void (i32,...)* @ clap_inst_pre (i32 2, i32 5, i32 0)
%inc = add nsw i32 %tmp,1, !dbg !58, !clap !60
call void (i32,...)* @ clap_inst_pre(i32 2, i32 6, i32 0)
store i32 %inc, i32*@a, align 4, !dbg !58, !clap !61
... ...

where function clap_inst_pre is an inserted monitoring sentence, which monitors a sentence thereafter and outputs a thread ID, an instruction ID, a state value and a returned value of the sentence thereafter in an execution process.

In step S2), the example program is executed at a given input and a path is recorded as [1, 2, 3, 4, 5, 6, 7, 8, 9, 10, 11, 12, 13, 14].

In step S3), the path is pre-processed for constraint construction in step S4), access points of global variables are extracted, which include lines 5, 6, 8, 9, 12 and 13, and the path is converted into an SSA format, where thread 0 is converted into track 0, thread 1 is converted into track 1 and thread 2 is converted into track 2, as is shown as follows:

0: x_{w}⁰ = 3, y_{w}⁰ = 1

| Track 0 | Track 1 | Track 2 |
|---|---|---|
| 1: create(1) | 5: a⁰ = xᵣ⁰; | 11: lock(m); |
| 2: create(2) | 6: b⁰ = yᵣ⁰; | 12: x_{w}² = xᵣ¹ + 1; |
| 3: join(1) | 7: lock(m); | 13: y_{w}² = yᵣ¹ + 1; |
| 4: join(2) | 8: x_{w}¹ = a⁰ + 2; | 14: unlock(m); |
| | 9: y_{w}¹ = b⁰ + 3; | |
| | 10: unlock(m); | |

where subscripts of global variables x and y represent reading (r) or writing (w), superscripts are for telling different reading or writing operations apart and a superscript being 0 indicates an initial assigned value.

In step S4), with expected outputs of global variables x and y being 6 and 5 respectively, assertions x=6 and y=5 are inserted at the end. In addition, x=6 and y=5 are determined to be output uniqueness verification conditions, as is shown as follows:

0: x_{w}⁰ = 3, y_{w}⁰ = 1

| Track 0 | Track 1 | Track 2 |
|---|---|---|
| 1: create(1) | 5: a⁰ = xᵣ⁰; | 11: lock(m); |
| 2: create(2) | 6: b⁰ = yᵣ⁰; | 12: x_{w}² = xᵣ¹ + 1; |
| 3: join(1) | 7: lock(m); | 13: y_{w}² = yᵣ¹ + 1; |
| 4: join(2) | 8: x_{w}¹ = a⁰ + 2; | 14: unlock(m); |
| | 9: y_{w}¹ = b⁰ + 3; | |
| | 10: unlock(m); | |

15: assert (xᵣ² = 6) assert(yᵣ² = 5)

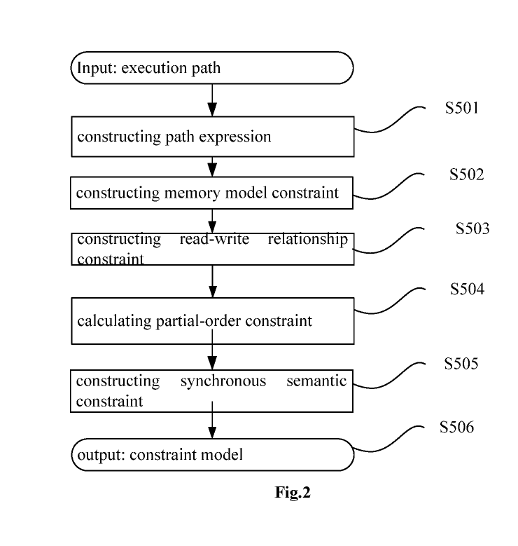

In step S5), state transfers and thread interleaving relationships in the execution path are converted into quantifier-free first-order logic expressions based on execution semanteme of the program, and a constraint model F of the execution path π, which includes five constraints: a path expression, a memory model constraint, a read-write relationship constraint, a partial-order constraint and a synchronous semantic constraint, is constructed. The whole constraint model F covers all possible interleave sequences. Specifically, as shown in FIG. 2, a corresponding logic expression is generated through the following steps S501) to S506).

Step S501), directly calculating, based on the SSA format of the path, the path expression, which is expressed by the following formula:

x⁰_{w}=3 [symbol] y⁰_{w}1 [symbol] a⁰=x⁰ᵣ [symbol] b⁰=y⁰ᵣ [symbol] x¹_{w}=a⁰+2 [symbol] y¹_{w}=b⁰+3 [symbol] x²_{w}=x¹ᵣ+1 [symbol] y²ᵣ=y¹ᵣ+1;

Step S502), constructing the memory model constraint, which includes performing all operations in accordance with an order of the program with a model with sequential consistency adopted, and calculating the memory model constraint of the path π according to the formula:

$${Φ}_{mo} = {}_{{T}_{i} ∈ I} ( {}_{{e}_{i} , {e}_{i + 1} ∈ {T}_{i}} O ( {e}_{i} ) < O ( {e}_{i + 1} ) ) ,$$

which is expressed by the following formula:

o(e₁)<o(e₂)<o(e₃)<o(e₄) [symbol] o(e₅)<o(e₆)<o(e₇)<o(e₈)<o(e₉)<o(e₁₀) [symbol] o(e₁₁)<o(e₁₂)<o(e₁₃)<o(e₁₄),

where o(eᵢ) represents a serial number of an interleave sequence of a sentence in an ith line.

Step S503) calculating the read-write relationship constraint, which includes letting reading of the shared variables be from recent writing, and for one shared variable, with R representing a set of all events performing a reading operation thereon and W representing a set of all event performing a writing operation thereon, providing the following formula:

$${Φ}_{rw} = {}_{{e}_{r} ∈ R} {}_{{e}_{w} ∈ W} \{ ( {v}_{r} = {v}_{w} ⋀ O ( {e}_{w} ) < O ( {e}_{r} ) ) ⋀ {}_{{e}_{x} ∈ W} ( O ( {e}_{x} ) < O ( {e}_{w} ) ⋀ O ( {e}_{r} ) < O ( {e}_{x} ) ) \} ,$$

where eᵣ is a read event, e_{w} and eₓ are write events, yᵣ and v_{w} are variables operated by events eᵣ and e_{w}, and the meaning of the formula is that a value of vᵣ in event eᵣ is from v_{w} in event e_{w} on condition that eᵣ is after e_{w}, that is O(e_{w})<O(eᵣ), and that all writing is either before e_{w} or after eᵣ.

In the path, for global variable x, R={e₅,e₁₂}, W={e₀,e₈,e₁₂} , and a read-write relationship is expressed by the following formula:

{x⁰ᵣ=x⁰_{w} [symbol] O(e₀)<O(e₅) [symbol] (e₈)<O(e₁₂)} [symbol] {x⁰ᵣ=x¹_{w} [symbol] O(e₁₂)<O(e₅) [symbol] O(e₀)<O(e₁₂)},

where reading and writing possibilities of variable x are enumerated, and reading of x in line 5 is from writing of x in line 0 on condition that line 0 is before line 5 and writing of x in line 12 must not occur between reading of x in line and writing of x in line 0. A situation in a case of variable y is similar to that in a case of variable x.

Step S504) constructing the synchronous semantic constraint, which includes two kinds of operations, lock/unlock operations and wait/signal operations:

1), in constructing a locked synchronous semantic constraint (that is, performing the lock/unlock operations), it is required that any two lock/unlock event pairs lᵢ/uᵢ and lₖ/uₖ in a lock/unlock set L in one mutex are subject to the following formula:

$${Φ}_{syn}^{l / u} = {}_{{l}_{i} / {u}_{i} , {l}_{k} / {u}_{k} ∈ L} O ( {u}_{i} ) < O ( {l}_{k} ) ⋁ O ( {u}_{k} ) < O ( {l}_{i} ) ,$$

where lock pair lᵢ/uᵢ occurs either before or after lock pair lₖ/uₖ; and

2) in constructing a synchronous semantic constraint for condition variables (that is, performing the wait/signal operations), it is required to meet the condition that each wait operation corresponds to one signal operation and one signal operation awakes one wait operation at most, and for one condition variable cond, with WT representing a set of all wait operations on cond and SG representing a set of all signal operations on cond, the following formula is provided to meet the condition above:

$${Φ}_{syn}^{w / s} = {}_{{e}_{wt} ∈ WT} \{ ( {}_{{e}_{sg} ∈ {SG}_{wt}} O ( {e}_{wt} ) > O ( {e}_{sg} ) ⋀ {pair}_{wt}^{sg} = 1 ) ⋀ {\sum }_{e ∈ {SG}_{wt}}^{ } {pair}_{wi}^{e} = 1 \} ,$$

where e_{wt} is an element in WT, SG_{wt} represents a set of signal operations matching e_{wt}, e_{sg} is any signal operation event in SG_{wt}, whether e_{sg} matches e_{wt} is represented by whether variable pair^{sg}_{wt} is equal to 1, and the sub-formula Σ_{e∈SG}_{_{wt}}pair^{e}_{wt}=1 indicates that there has to be a signal operation matching each wait operation.

In the path, there is only a lock m, and the synchronous semantic constraint is expressed by the following formula:

o(e₁₀)<o(e₁₁) [symbol] o(e₁₄)<o(e₇)

where the constraint expression indicates that either thread 1 obtains the lock first, that is, o₆<o₇, or thread 2 obtains the lock first, that is, o₁₀<o₃.

Step S505) calculating the partial-order constraint, which provides that: if an event creates a thread, all events of the created thread are required to be executed after the event; and if an event performs a thread terminating operation, all events of a terminated thread are required to be before the event. With C representing a set of events of create/fork operations and J representing a set of events of join operations, the following constraint is provided:

$${Φ}_{po} = {}_{{e}_{c} ∈ C} O ( {e}_{c} ) < first ( {e}_{c} ) ⋀ {}_{{e}_{j} ∈ j} O ( {e}_{j} ) > last ( {e}_{j} ) ,$$

where e_{c} is a thread creating event, first (e_{c}) is a rank of the first event of a thread created by e_{c}, eⱼ is a thread terminating event and last(eⱼ) is a rank of the last event of a thread terminated by eⱼ.

In the path, thread creating sentences are o₂ and o₃ and a partial-order constraint thereof is expressed by the following formula:

o(e₁)<o(e₅) [symbol] o(e₂)<o(e₁₁) [symbol] o(e₁₀)<o(e₃) [symbol] o(e₁₄)<o(e₂),

where the constraint o(eᵢ)<o(e₅) represents that thread creating sentence eᵢ is executed before the first event e₅ of thread 1 created by e₁, and the constraint o(e₁₀)<o(e₃) represents that thread wait sentence e₃ is executed after the last event e₁₀ of thread 1.

Step S506) obtaining the constraint model F by combining the five constraints above.

In step S6) in the example, with the output uniqueness verification conditions being ρ₁:x=6 and ρ₂:y =5, F [symbol] ρ₁ and F [symbol] ρ₂ are solved with a constraint solver, each of which has a solution, where a counter-example of ρ₁ is {1,2,5,11,12,13,14,6,7,8,9,10} and a counter-example of ρ₂ is {1,2,5,6,11,12,13,14,7,8,9,10}.

In step S7), a verification result and the counter-examples are outputted.

What is claimed is:

1. A program constraint construction based method for examining output uniqueness of a multithread program and generating proof, comprising:
step S1), embedding monitoring code into a program to be tested, to record an execution process of the program;
step S2), executing the instrumented program at a given input, and generating a path record file;
step S3), pre-processing an execution path to facilitate constraint construction;
step S4), automatically adding an attribute condition at the end of running of the program, and for a running output of the multithread program, inserting an output uniqueness condition ρ into the program in the form of assert;
step S5), converting, based on execution semanteme of the program, state transfers and thread interleaving relationships in the execution path into quantifier-free first-order logic expressions, and constructing a multithread program execution path constraint model F covering all possible interleave sequences;
step S6), verifying whether there is a solution to F [symbol] ρ given the uniqueness condition ρ; and
step S7), generating a proof sequence if there is a solution which indicates existence of a plurality of different outputs, and determining that output is unique at the given input if there is no solution,
wherein the multithread program execution path constraint model F in step S5) covers all possible interleave sequences of the execution path, and comprises five constraints: a path expression, a memory model constraint, a read-write relationship constraint, a partial-order constraint and a synchronous semantic constraint, which are defined as follows:
1), the path expression: describing definition-use chains inside threads and controlling state switching inside the threads;
2), the memory model constraint: representing relationships between sentences and between variables in a program and adopting semanteme with sequential consistency, wherein the sequential consistency provides that a CPU executes a program in an order of sentences in code;
3), the read-write relationship constraint: defining definition-use chains across the threads, and providing that a value read by a shared variable must be from an initial value and a value written recently;
4), the partial-order constraint: defining sequential relationships between operating sentences for creating and terminating a thread and sentences of an operated thread across the threads;
5), the synchronous semantic constraint: defining sequential relationships between synchronization control operating sentences across the threads;
wherein the definition-use chain is defined as follows: with each thread sequence converted into an SSA format, each execution sequence of the SSA format except shared access points is a complete definition-use chain,
wherein a method for constructing the multithread program execution path constraint model F in step S5) comprises the following operations:
1), calculating the path expression to control the state switching inside the threads;
2), calculating the memory model constraint to restrict relationships between sentences in each of the threads;
3), calculating the read-write relationship constraint to establish the definition-use chains across the threads:
4), calculating the synchronous semantic constraint to define synchronization relationships between the threads;
5), calculating the partial-order constraint to describe semanteme for creating and terminating the threads; and
forming the constraint model F by combining the five constraints above,
wherein, with an event set of the execution path defined as [symbol] ₙ={Tᵢ|0<i≦k}, wherein k is the number of the threads, Tᵢ={e₁,e₂, . . . ,eₙ} is an execution sequence of thread i, eₙ represents an nth event of Tᵢ, O(eₙ) represents a rank of event eₙ and n represents the number of events in Tᵢ,
a method for calculating the path expression comprises:
converting each thread sequence into an SSA format, and directly converting the sequence of the SSA format into the path expression;
a method for calculating the memory model constraint comprises:
performing all operations in accordance with an order of the program with a model with sequential consistency adopted, wherein an order of events in a thread is subject to the following constraint:
$${Φ}_{mo} = {}_{{T}_{i} ∈ τ} ( {}_{{e}_{i} , {e}_{i + 1} ∈ {T}_{i}} O ( {e}_{i} ) < O ( {e}_{i + 1} ) ) ,$$
wherein eᵢ and eᵢ₊₁ represent two successive events in one thread and τ represents all thread sequences;
a method for calculating the read-write relationship constraint comprises:
letting reading of the shared variable be from recent writing, and for one shared variable v, with R representing a set of all events performing a reading operation thereon and W representing a set of all event performing a writing operation thereon, providing the following formula:
$${Φ}_{rw} = {}_{{e}_{r} ∈ R} {}_{{e}_{w} ∈ W} \{ ( {v}_{r} = {v}_{w} ⋀ O ( {e}_{w} ) < O ( {e}_{r} ) ) ⋀ {}_{{e}_{x} ∈ W} ( O ( {e}_{x} ) < O ( {e}_{w} ) ⋀ O ( {e}_{r} ) < O ( {e}_{x} ) ) \} ,$$
wherein eᵣ is a read event, e_{w} and eₓ are write events, vᵣ and v_{w} are variables operated by events eᵣ and e_{w}, and the meaning of the formula is that a value of vᵣ in event eᵣ is from v_{w} in event e_{w} on condition that eᵣ is after e_{w}, that is O(e_{w})<O(eᵣ), and that all writing is either before e_{w}, or after eᵣ;
a method for calculating the synchronous semantic constraint comprises two kinds of operations, lock/unlock operations and wait/signal operations:
1), the lock/unlock operations are for constructing a locked synchronous semantic constraint, which requires that any two lock/unlock event pairs lᵢ/uᵢ and lₖ/uₖ in a lock/unlock set L in one mutex are subject to the following formula:
$${Φ}_{syn}^{l / u} = {}_{{l}_{i} / {u}_{i} , {l}_{k} / {u}_{k} ∈ L} O ( {u}_{i} ) < O ( {l}_{k} ) ⋁ O ( {u}_{k} ) < O ( {l}_{i} ) ,$$
wherein lock pair lᵢ/uᵢ occurs either before or after lock pair lₖ/uₖ; and
2) the wait/signal operations are for constructing a synchronous semantic constraint for condition variables, which is subject to the condition that each wait operation corresponds to one signal operation and one signal operation awakes one wait operation at most, and for one condition variable cond, with WT representing a set of all wait operations on cond and SG representing a set of all signal operations on cond, the following formula is provided to meet the condition above:
$${Φ}_{syn}^{w / s} = {}_{{e}_{wt} ∈ WT} \{ ( {}_{{e}_{sg} ∈ {SG}_{wt}} O ( {e}_{wt} ) > O ( {e}_{sg} ) ⋀ {pair}_{wt}^{sg} = 1 ) ⋀ {\sum }_{e ∈ {SG}_{wt}}^{ } {pair}_{wi}^{e} = 1 \} ,$$
wherein e_{wt} is an element in WT, SG_{wt} represents a set of signal operations matching e_{wt}, e_{sg} is any signal operation event in SG_{wt}, whether e_{sg} matches e_{wt} is represented by whether variable pair^{sg}_{wt} is equal to 1, and the sub-formula Σ_{e∈SG}_{_{wt}}pair^{e}_{wt}=1 indicates that there has to be a signal operation matching each wait operation;
a method for calculating the partial-order constraint comprises:
providing that if an event creates a thread, all events of the created thread are required to be executed after the event and that if an event performs a thread terminating operation, all events of a terminated thread are required to be before the event, and with C representing a set of events of create/fork operations and J representing a set of events of join operations, providing the following constraint:
$${Φ}_{po} = {}_{{e}_{c} ∈ C} O ( {e}_{c} ) < first ( {e}_{c} ) ⋀ {}_{{e}_{j} ∈ j} O ( {e}_{j} ) > last ( {e}_{j} ) ,$$
wherein e_{c} is a thread creating event, first (e_{c}) is a rank of the first event of a thread created by e_{c}, eⱼ is a thread terminating event and last(eⱼ) is a rank of the last event of a thread terminated by eⱼ; and
the five constraints above are combined to form the constraint model F.

2. The program constraint construction based method for examining output uniqueness of a multithread program and generating proof according to claim 1, wherein the instrumentation in step S1) is not performed at a source code or binary level but at a bytecode level, wherein a specific implementing method thereof comprises: first converting source code of the multithread program to be tested into bytecode of an intermediate format, that is, LLVM bytecode; then embedding a sentence with a monitoring function into the program to be tested; and finally linking the bytecode with the monitoring code embedded in to generate an executive program.

3. The program constraint construction based method for examining output uniqueness of a multithread program and generating proof according to claim 1, wherein the pre-processing in step S3) comprises extracting a shared variable to recognize an access point of a public variable in the execution path, and slicing to remove an executive sentence irrelevant to a verification attribute.

4. The program constraint construction based method for examining output uniqueness of a multithread program and generating proof according to claim 1, wherein an output variable is automatically recognized and the output uniqueness condition ρ is constructed therefor in step S4).

5. The program constraint construction based method for examining output uniqueness of a multithread program and generating proof according to claim 1, wherein, with the given constraint model and the output uniqueness attribute condition, the attribute condition is solved for with the constraint solver in step S6), and if there is a different output, a counter-example is generated to describe a triggering process of the different output.
